(19) United States
(12) Patent Application Publication
(10) Pub. No.: US 2014/0329103 A1
(43) Pub. Date: Nov. 6, 2014

(54) MULTILAYER FILM

(71) Applicant: Avery Dennison Corporation, Glendale, CA (US)

(72) Inventors: Vadim ZAIKOV, Perry, OH (US); Wen-Li (Adam) A. Chen, Rochester, NY (US)

(73) Assignee: Avery Dennison Corporation, Glendale, CA (US)

(21) Appl. No.: 14/265,906

(22) Filed: Apr. 30, 2014

Related U.S. Application Data
(60) Provisional application No. 61/818,025, filed on May 1, 2013.

(51) Int. Cl. B32B 27/08; B32B 27/30; B32B 27/32

(52) U.S. Cl. CPC B32B 27/08; B32B 27/32; B32B 27/306; B32B 2250/03; B32B 2250/246; B32B 2307/72; B32B 2307/7163; B32B 2317/00; B32B 2323/046; B32B 2553/00; B32B 2323/10
USPC 428/516

(57) ABSTRACT

A multilayer polyolefin film useful for packaging contains a core layer including from 20% to 100% by weight of the core layer of a polyethylene homopolymer having a density of between about 0.94 and about 0.97; an ethylene/alpha-olefin copolymer having a density of between about 0.94 and about 0.97; polypropylene; or a mixture thereof; from 0% to 80% by weight of the core layer of linear low density polyethylene, low density polyethylene, a copolymer of ethylene and vinyl acetate; or a mixture thereof; and a skin layer laminated to the core layer. The skin layer is a layer of linear low density polyethylene, low density polyethylene, a copolymer of ethylene and vinyl acetate; or a mixture thereof. At least one of the core layer and the skin layer includes at least 20% modern carbon. If desired, two skin layers may be laminated to opposing surfaces of the core layer.

### CROSS-REFERENCE TO RELATED APPLICATION(S)

The present application claims priority from U.S. Provisional Application No. 61/818,025 filed May 1, 2013 which is incorporated by herein by reference in its entirety.

### BACKGROUND OF THE INVENTION

This disclosure relates generally to polyolefin films produced at least partially from biomass.

As discussed in U.S. Patent Publication 2012/0074027, incorporated herein by reference, the environmental impact of consumer products and their packaging has become of increasing environmental concern. Product packaging produced from petroleum-based sources, such as polyethylene, may undergo degradation or combustion, producing carbon dioxide as a product. Carbon dioxide is a greenhouse gas, and contributes to global warming. Greenhouse gases absorb infrared radiation from the sun, thereby trapping heat in the Earth's atmosphere. The increase in the quantity of greenhouse gases in the atmosphere is thought to have increased the retained heat on the Earth's surface contributing to global warming.

Product packaging produced from biomass-based sources, such as plant sources, also undergoes degradation or combustion, producing carbon dioxide as a product. However, CO₂ is cycled by plants to make organic molecules during photosynthesis in accordance with the carbon cycle. Plants metabolize CO₂ into more complex molecules during photosynthesis. Plants and other forms of life then metabolize these complex molecules producing CO₂, which is released back to the atmosphere. Packaging produced from plant sources do not contribute to global warming as there is no net increase in the amount of carbon emitted into the biosphere. Rather, any CO₂ produced from plant-based packaging merely restores CO₂ previously removed by the plant raw material. In contrast, petroleum-based packaging released carbon previously stored underground into the atmosphere ultimately contributing to global warming.

Approximately ninety nine percent (99%) of the carbon in the Earth's biosphere is carbon-12 (12C), which is a stable isotope of carbon. The remaining one percent (1%) of the carbon in the Earth's biosphere is substantially comprised of carbon-13 (13C), which is also a stable isotope of carbon, with trace amounts of radioactive carbon-14 (14C) being present. Plants and other forms of life metabolize 14C, which becomes part of all life and their biological products. In contrast, petroleum-based carbon does not include a signature amount of 14C. Accordingly, petroleum-based materials and biomass-based materials may be distinguished based on their 14C content.

Testing methods for distinguishing petroleum-based materials and biomass-based materials based on their 14C content include isotope ratio mass spectrometry analysis. Specifically, ASTM International has established a standard method for assessing the biobased content of materials, which it has designated as ASTM-D6866. ASTM-D6866 is built on the same concepts as radiocarbon dating, but without the use of age equations. The analysis includes deriving a ratio of the amount of radiocarbon (14C) in an unknown sample to that of a modern reference sample. The ratio is reported as a percentage having the units of “pMC” (percent modern carbon). For example, if the material being analyzed is a mixture of present day ¹⁴C and fossil carbon, then the pMC value obtained directly correlates to the amount of biomass material present in the sample.

The modern reference sample used in radiocarbon dating is a standard reference material (“SRM”) of the national institute of Standards and Technology (“NIST”) having a known radiocarbon content approximately equivalent to the year 1950, which is a time prior to nuclear weapons testing that introduced significant amounts of excess radiocarbons into the atmosphere. The 1950 reference represents 100 pMC. Due to nuclear weapons testing, modern biological carbon sources have a greater pMC than the standard reference material. For example, the pMC value for wood or another biomass-derived carbon source obtained in 2010 is approximately 107.5 pMC.

Combining fossil carbon with radiocarbon into a single material results in a dilution of the pMC content. For example, if a material comprises fifty percent (50%) fossil carbon having a value of zero pMC and fifty percent (50%) radiocarbon having a 107.5 pMC, then the resultant material would have a radiocarbon signature close to 54 pMC. A biomass content may be derived by assigning one hundred percent (100%) equal to a value of 107.5 pMC and zero percent to a value of zero pMC such that a sample measuring 99 pMC provides an equivalent biobased content of approximately ninety three percent (93%).

### SUMMARY OF THE INVENTION

A brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments disclosed herein relate to a multilayer polyolefin film, and one such embodiment includes a film that has a core layer containing:

a) from 20% to 100% by weight of the core layer of a polyethylene homopolymer having a density of between about 0.94 and about 0.97; an ethylene/alpha-olefin copolymer having a density of between about 0.94 and about 0.97; polypropylene; or a mixture thereof; and

b) from 0% to 80% by weight of the core layer of linear low density polyethylene, low density polyethylene, a copolymer of ethylene and vinyl acetate; or a mixture thereof; and at least one skin layer laminated to said core layer.

The skin layer comprises a layer of linear low density polyethylene, low density polyethylene, a copolymer of ethylene and vinyl acetate; or a mixture thereof. At least one of the core layer and the skin layer comprises at least 20% modern carbon. In some embodiments, both of the core layer and the skin layer comprise at least 20% modern carbon. The core layer and the skin layer may comprise at least 20% modern carbon, at least 30% modern carbon, at least 40% modern carbon, at least 50% modern carbon, at least 60% modern carbon, or at least 80% modern carbon. The core layer and the skin layer may each comprise between 30% and 107.5% modern carbon.

In various embodiments, the core layer comprises from 40% to 100% by weight of a polyethylene homopolymer having a density of between about 0.94 and about 0.97 or an ethylene/alpha-olefin copolymer having a density of between about 0.94 and about 0.97. In some embodiments, the skin layer comprises a layer of linear low density polyethylene.

In various embodiments, the multilayer polyolefin film comprises two skin layers laminated to opposite sides of the core layer.

In various embodiments, the core layer comprises a polyethylene homopolymer or an ethylene/alpha-olefin copolymer having a density of between about 0.94 and about 0.97. These polymers are produced by polymerization of ethylene derived from biomass or copolymerization of ethylene derived from biomass and an alpha-olefin. At least a portion of the ethylene may be produced by fermentation of sugarcane juice by Propionibacterium acidipropionici to produce propionic acid, which is then subjected to anodic electro-decarboxylation to produce ethylene.

In some embodiments, the core comprises a polypropylene polymer, produced by polymerization of propylene derived from biomass. The propylene derived from biomass may be produced by fermentation of sugarcane juice by Clostridium butyricum to produce butyric acid, which is subjected to an anodic electro-decarboxylation reaction to produce propylene.

The skin layer may comprise a layer of linear low density polyethylene produced by co-polymerization of ethylene and an alpha-olefin, where the ethylene is produced from biomass. At least a portion of the ethylene may be produced by fermentation of sugarcane juice by Propionibacterium acidipropionici to produce propionic acid, which is then subjected to anodic electro-decarboxylation to produce ethylene.

The laminates according to the present disclosure contain polymers of biologically derived olefin monomers, and promote the mitigation of carbon dioxide from the atmosphere. The polymers of biologically derived olefin monomers, such as polyethylene and polypropylene, as well as the products manufactured from such polymers, generate carbon dioxide of non-fossil origin when incinerated.

Packaging manufactured from the films described in this application may be used in a number of end use applications, including for example apparel and garment packaging as well as other products, such as electronics, food, and the like.

### DETAILED DESCRIPTION OF THE INVENTION

The current disclosure is directed to an ethylene- or propylene-based composite film, manufactured from bio-based ethylenic polymers. In the following disclosure, density should be understood to be measured in g/cm³.

The current disclosure is directed to a composite film structure provided by an ethylene- or propylene-based composite film structure comprising a core layer (A) of high density polyethylene, polypropylene, or a mixture thereof; and at least one skin layer (B) laminated to a surface of layer (A). High density polyethylene, as used in core layer (A), is defined as a polyethylene homopolymer having a density of between about 0.94 and about 0.97, or an ethylene/alpha-olefin copolymer having a density of between about 0.94 and about 0.97.

In one embodiment contemplated by the present invention, the HDPE contains a trace amount of 1-butene. The ethylene/alpha-olefin copolymer having a density of between about 0.94 and about 0.97 may contain up to 2% by weight of at least one alpha-olefin comonomer, up to 1% by weight of at least one alpha-olefin comonomer, or up to 0.5% by weight of at least one alpha-olefin comonomer. Suitable alpha-olefin comonomers include linear or branched alpha-olefins having from 3 to 18 carbon atoms, from 4 to 10 carbon atoms, or from 5 to 8 carbon atoms. Suitable alpha-olefin comonomers include propylene, 1-butene, 1-pentene, 1-hexene and 4-methyl-1-pentene.

In various embodiments, the high density polyethylene used in core layer (A) is prepared by polymerization of ethylene derived from a bio-based source, optionally ethylene derived from a petroleum-based source, and optionally an alpha-olefin. Polymerization is carried out using a Zeigler-Natta catalyst using methods known in the art. The bio-based ethylene may be produced by fermentation of sugarcane juice by Propionibacterium acidipropionici to produce propionic acid, which is then subjected to anodic electro-decarboxylation to produce ethylene, as disclosed in WO 2011/066634, incorporated herein by reference in its entirety. The amount of ethylene derived from a bio-based source used in the polymerization to produce high density polyethylene is sufficient to produce high density polyethylene which comprises at least 20% modern carbon, at least 30% modern carbon, at least 40% modern carbon, at least 50% modern carbon, at least 60% modern carbon, or at least 80% modern carbon. The high density polyethylene may comprise between 30% and 107.5% modern carbon.

In various embodiments, the polypropylene used in core layer (A) is prepared by polymerization of propylene derived from a bio-based source and optionally propylene derived from a petroleum-based source. Polymerization is carried out using a Zeigler-Natta catalyst using methods known in the art. The bio-based propylene is produced by fermentation of sugarcane juice by Clostridium butyricum to produce butyric acid, which is subjected to an anodic electro-decarboxylation reaction to produce propylene, as disclosed in WO 2011/066634. The amount of propylene derived from a bio-based source used in the polymerization to produce polypropylene is sufficient to produce polypropylene which comprises at least 20% modern carbon, at least 30% modern carbon, at least 40% modern carbon, at least 50% modern carbon, at least 60% modern carbon, or at least 80% modern carbon. The polypropylene may comprise between 30% and 107.5% modern carbon.

Skin layer (B) comprises a layer of linear low density polyethylene, low density polyethylene, a copolymer of ethylene and vinyl acetate (EVA); or a mixture thereof. In certain embodiments, core layer (A) comprises from 20% to 100% by weight of high density polyethylene, polypropylene, or a mixture thereof; and from 0% to 80% by weight of linear low density polyethylene, low density polyethylene, EVA, or a mixture thereof.

The linear low density polyethylene used in layers (A) and/or (B) may be a random copolymer of ethylene and at least one C₅-C₁₀ alpha-olefin comonomer, e.g., propylene, 1-butene, 1-pentene, 1-hexene or 4-methyl-1-pentene, having a density of between about 0.90 g/cm³ and 0.94 g/cm³. The linear low density polyethylene may be a polymer of density of between 0.925 and 0.94, containing up to 2% comonomer; a polymer of density of between 0.915 and 0.925, containing 2.5% to 3.5% comonomer; or a polymer of density of less than 0.915, containing >4% comonomer. In various embodiments, the linear low density polyethylene may be a polymer prepared using a single-site catalyst, having a density of less than 0.912 and containing >25% comonomer. In various embodiments, the comonomer is 1-butene, 1-hexene, 1-octene, or a mixture thereof. In various embodiments, the linear low density polyethylene contains up to 25% comonomer and at least 75% ethylene, up to 10% comonomer and at least 90% ethylene, or from 1% to 5% cornonomer and from 95% to 99% ethylene. If layer (A) contains linear low density polyethylene, the linear low density polyethylene used in layer (A) may be the same as or different from the linear low density polyethylene used in layer (B).

The low density polyethylene used In layers (A) and/or (B) may be a highly branched ethylene homopolymer having a density of between about 0.90 g/cm³ and 0.94 g/cm³. The copolymer of ethylene and vinyl acetate (also known as EVA) used in layers (A) and/or (B) is a copolymer of ethylene and vinyl acetate. The EVA copolymer contains from 10% by weight to 40% by weight vinyl acetate, with the balance of the copolymer being ethylene.

The linear low density polyethylene used in skin layer (B), and optionally in core layer (A), is prepared by copolymerizing ethylene derived from a bio-based source, optionally ethylene derived from a petroleum-based source, and an alpha-olefin. Polymerization is carried out using a Zeigler-Natta or Philips-type catalyst using methods known in the art. The bio-based ethylene may be produced by fermentation of sugarcane juice by Propionibacterium acidipropionici to produce propionic acid, which is then subjected to anodic electro-decarboxylation to produce ethylene, as disclosed in WO 2011/066634. The amount of ethylene derived from a bio-based source used in the polymerization to produce linear low density polyethylene is sufficient to produce linear low density polyethylene which comprises at least 20% modern carbon, at least 30% modern carbon, at least 40% modern carbon, at least 50% modern carbon, at least 60% modern carbon, or at least 80% modern carbon. The linear low density polyethylene may comprise between 30% and 107.5% modern carbon.

The low density polyethylene used in skin layer (B), and optionally in core layer (A), is prepared by polymerizing ethylene derived from a bio-based source and optionally ethylene derived from a petroleum-based source. Polymerization is carried out using a Zeigler-Natta catalyst using methods known in the art. The bio-based ethylene may be produced by fermentation of sugarcane juice by Propionibacterium acidipropionici to produce propionic acid, which is then subjected to anodic electro-decarboxylation to produce ethylene. The amount of ethylene derived from a bio-based source used in the polymerization to produce low density polyethylene is sufficient to produce low density polyethylene which comprises at least 20% modern carbon, at least 30% modern carbon, at least 40% modern carbon, at least 30% modern carbon, at least 60% modern carbon, or at least 80% modern carbon. The low density polyethylene may comprise between 30% and 107.5% modern carbon.

The EVA used in skin layer (B), and optionally in core layer (A), is prepared by copolymerizing ethylene derived from a bio-based source, optionally ethylene derived from a petroleum-based source, and vinyl acetate. Polymerization is carried out using methods known in the art. The bio-based ethylene is produced by fermentation of sugarcane juice by Propionibacterium acidipropionici to produce propionic acid, which is then subjected to anodic electro-decarboxylation to produce ethylene. The amount of ethylene derived from a bio-based source used in the polymerization to produce EVA is sufficient to produce EVA which comprises at least 20% modern carbon, at least 30% modern carbon, at least 40% modern carbon, at least 50% modern carbon, at least 60% modern carbon, or at least 70% modern carbon.

In various embodiments, the skin layer (B) is laminated to one surface of the core layer (A). In some embodiments, two skin layers (B) are laminated to opposing surfaces of core layer (A). The thickness of the skin layer or layers (B) is about 1 to 40 microns (0.04 mil to 1.57 mil), about 5 to 35 microns (0.20 mil to 1.38 mil), or about 15 to 30 microns (0.59 mil to 1.18 mil). The thickness of the core layer (A) is suitably about 50 to 200 microns (2 mil to 7.9 mil), about 100 to 175 microns (3.9 mil to 6.9 mil), or about 125 to 175 microns (4.9 mil to 6.9 mil).

For forming a composite film having the structure (B)/(A) or (B)/(A)/(B), any suitable means that can laminate a layer or layers (B) to one or both sides of layer (A) can be employed. At least one layer (B) may be laminated to layer (A) by melt-extrusion of layer (B) to a layer (A) that has been formed in advance; or by melt-coextrusion of a skin layer or layers (B) and a core layer (A) using a die having a two- or three-layer structure. As the coextrusion molding method, there is the T-die method which uses a flat die or the inflation method which uses a circular die. In the case of the flat die, both the single manifold setup and the multimanifold setup using a black box are usable. In the coextrusion molding method, the core layer may be extruded as a single layer, or as two adjacent layers of identical composition. If the core layer is extruded as two adjacent layers, the adjacent layers may have different thicknesses or identical thicknesses. In the coextrusion molding method, the core layer and the skin layer(s) may be coextruded as a flat sheet. The coextruded film may be nonoriented, biaxially oriented, monoaxially oriented by stretching in the machine direction, or monoaxially oriented by stretching in the cross direction.

If the inflation method is elected as the coextrusion molding method, the core layer and a single skin layer may be coextruded as a tubular film, with the skin layer on the outer surface of the tubular film and the core layer on the inner surface. The tubular film may then be collapsed into a sheet, and the resulting sheet will have a core layer, sandwiched between two skin layers.

When forming a composite film having the structure (B)/(A) or (B)/(A)/(B), a casting method may be selected to produce a nonoriented film. The casting method allows sequential deposition of a polymer melt or solution suitable for forming skin layer (B), a polymer melt or solution suitable for forming core layer (A), and, if desired, a polymer melt or solution suitable for forming a second skin layer (B) against a forming surface.

The composite film disclosed herein may contain various additives. The skin layers (B) can contain as additives antiblocking agents, such as silica; slipping agents, such as erucamide, oleic acid amide and ethylene bis fatty acid amides; lubricants, such as calcium stearate, paraffin and higher fatty acids; and colorants, such as yellow iron oxide, red iron oxide and titanium dioxide. The core layer (A) may contain colorants, such as yellow iron oxide, red iron oxide and titanium dioxide.

In various embodiments, at least one skin layer (B) may be made into a printable surface by subjecting the exposed surface of the skin layer to corona discharge. A polyolefin layer may be rendered at a higher polarity as its exposed surfaces by subjection to a corona discharge or other ionizing condition, preferably in air or a similar oxygen-containing atmosphere. The hydrophilic polyolefin surface may then be printed with a suitable ink.

In various embodiments, the film is a 3 layer film with two skin layers. Each skin layer makes up 10% of the total film thickness. Each skin layer comprises LLDPE and 1% by weight of a silica antiblocking agent in a petroleum-based LDPE or a bio-based LDPE. The antiblocking agent may also be DE or an organic antiblocking agent. The core layer makes up 80% of the total film thickness. The core layer comprises biobased HDPE or a blend of biobased LLDPE and biobased HDPE. The core layer may be prepared with addition of a colorant concentrate, such as a TiO₂ concentrate. The colorant concentrate is a concentrate formed by compounding TiO₂ concentrate in a petroleum-based HDPE or a bio-based HDPE.

### EXAMPLE 1

TABLE 1

| Extruder | Supplier # | Chemistry | d | Ml | 1 | 2 | 3 | 4 | 5 | 6 | 7 | 8 | 9 | 10 | 11 | 12 |
|---|---|---|---|---|---|---|---|---|---|---|---|---|---|---|---|---|
| D: Air | SLH218 | LLDPE-He | 0.916 | 2.3 | 99 | | | | | | | | | | | |
| knife | AB5 | AB/LDPE | 0.952 | 17 | 1.0 | | | | | | | | | | | |
| C: Tie | SLH218 | LLDPE-He | 0.916 | 2.3 | | | | | 25 | | | | 55 | | | |
| | SHE150 | HDPE-Bu | 0.948 | 1.0 | 80 | | | | 55 | | | | 25 | | | |
| | BioHD | TiO2/HDPE(S150) | | | 20 | | | | | | | | | | | |
| | 8061 | | | | | | | | | | | | | | | |
| | 110LT9699 | TiO2 in SLH218 | 1.720 | | | | | | | | | | | | | |
| | 111712 | TiO2/LLDPE | 2.030 | 14 | | | | | | | | | | | | |
| B: Core | SLH218 | LLDPE-HE | 0.916 | 2.3 | | | | | 25 | | | | 55 | | | |
| | SHE150 | HDPE-Bu | 0.948 | 1.0 | 80 | | | | 55 | | | | 25 | | | |
| | BioHD | TiO2/HDPE(S150) | | | 20 | | | | | | | | | | | |
| | 8061 | | | | | | | | | | | | | | | |
| | 110LT9699 | TiO2 in SLH218 | 1.720 | | | | | | | | | | | | | |
| | 111712 | TiO2/LLDPE | 2.030 | 14 | | | | | | | | | | | | |

| | | | | | |
|---|---|---|---|---|---|
| A: Cast | SLH218 | LLDPE-He | 0.916 | 2.3 | 99 |
| roll - (Print) | AB5 | AB/LDPE | 0.952 | 17 | 1.0 |

| | | | | | | | | | | | | |
|---|---|---|---|---|---|---|---|---|---|---|---|---|
| Caliper, mil | 3 | 5 | 7 | 3 | 3 | 5 | 7 | 3 | 3 | 5 | 7 | 3 |

| | | | | | | | | |
|---|---|---|---|---|---|---|---|---|
| 60 | lb/roll | Cast or MDO | Cast | M | Cast | M | Cast | M |

| Extruder, RPM | | | | Calc. layer, % | | | | |
|---|---|---|---|---|---|---|---|---|
| A | B | C | D | A | B | C | D | lb/h |
| 46 | 50 | 40 | 50 | 10 | 10 | 70 | 10 | 696 |
| 66 | 70 | 52 | 71 | | | | | 932 |
| 90 | 90 | 64 | 93 | | | | | 1,145 |
| 104 | 100 | 69 | 104 | | | | | 1,243 |

| Matte cast roll | 3 kW corona treatment of cast roll side |
|---|---|
| Nip pinning | 8″ wide 1000 ft long rolls and handsheets |
| 4-1ayer feedblock | |

Table 1 represents a composite film as disclosed herein. Tie layer (C) and Core layer (B) collectively comprise a core layer as disclosed herein, and contain a high-density polyethylene containing bio-based ethylene and up to 2% of a 1-butene comonomer, alone or in combination with a linear low density polyethylene containing bio-based ethylene and a 1-hexene monomer. The core layer contains no linear low density polyethylene, 23% by weight of linear low density polyethylene, or 55% by weight of linear low density polyethylene. The core layer also contains a titanium dioxide colorant. Layers (A) and (0) are skin layers as disclosed herein, and contain a linear low density polyethylene containing bio-based ethylene and up to 2% of a 1-hexene comonomer. Layers (A) and (D) each contain silica as an antiblocking agent. Layer (A), but not layer (D), has been corona-treated to improve printability.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A multilayer polyolefin film, comprising:
a core layer comprising:
a) from 20% to 100% by weight of the core layer of a polyethylene homopolymer having a density of between about 0.94 and about 0.97; an ethylene/alpha-olefin copolymer having a density of between about 0.94 and about 0.97;polypropylene;
or a mixture thereof; and
b) from 0% to 80% by weight of the core layer of linear low density polyethylene, low density polyethylene, a copolymer of ethylene and vinyl acetate; or a mixture thereof; and
at least one skin layer laminated to said core layer, said at least one skin layer comprising a layer of linear low density polyethylene, low density polyethylene, a copolymer of ethylene and vinyl acetate; or a mixture thereof;
wherein at least one of said core layer and said at least one skin layer comprises at least 20% modern carbon.

2. The multilayer polyolefin film of claim 1, wherein said core layer comprises from 40% to 100% by weight of the core layer of a polyethylene homopolymer having a density of between about 0.94 and about 0.97 or an ethylene/alpha-olefin copolymer having a density of between about 0.94 and about 0.97.

3. The multilayer polyolefin film of claim 1, wherein said at least one skin layer comprises a layer of linear low density polyethylene.

4. The multilayer polyolefin film of claim 1, wherein each of said core layer and said at least one skin layer comprises between 30% modern carbon and 107.5% modern carbon.

5. The multilayer polyolefin film of claim 1, wherein said multilayer polyolefin film has two skin layers laminated to opposite sides of said core layer.

6. The multilayer polyolefin film of claim 2, wherein said core layer comprises:
a polyethylene homopolymer having a density of between about 0.94 and about 0.97 produced by polymerization of ethylene; or
an ethylene/alpha-olefin copolymer having a density of between about 0.94 and about 0.97 produced by co-polymerization of ethylene and an alpha-olefin;
wherein at least a portion of said ethylene Is produced by fermentation of sugarcane juice by Propionibacterium acidipropionici to produce propionic acid, which is then subjected to anodic electro-decarboxylation to produce ethylene.

7. The multilayer polyolefin film of claim 2, wherein said skin layer comprises a layer of linear low density polyethylene produced by co-polymerization of ethylene and an alpha-olefin;
wherein at least a portion of said ethylene is produced by fermentation of sugarcane juice by Propionibacterium acidipropionici to produce propionic acid, which is then subjected to anodic electro-decarboxylation to produce ethylene.

8. A multilayer polyolefin film as recited in claim 1, wherein the film is used in connection with apparel and garment packaging and consumer goods.
